(19) United States
(12) Patent Application Publication
(10) Pub. No.: US 2026/0258795 A1
(43) Pub. Date: Sep. 3, 2026

(54) LINEAR NATURAL GAS COMPRESSOR WITH HYDRAULIC MOTOR

(71) Applicant: The Williams Companies, Inc., Tuisa, OK (US)

(72) Inventor: Tyler King, Belle Vernon, PA (US)

(73) Assignee: The Williams Companies, Inc., Tuisa, OK (US)

(21) Appl. No.: 19/554,476

(22) Filed: Mar. 2, 2026

Related U.S. Application Data
(60) Provisional application No. 63/765,425, filed on Feb. 28, 2025.

(51) Int. Cl. F04B 35/00; F04B 25/00; F15B 15/18

(52) U.S. Cl. CPC F04B 35/00; F04B 25/00; F15B 15/18

(57) ABSTRACT

A system for evacuating gases from a source to destination includes a natural gas compressor that is driven by hydraulic pressure, which may be available from a passenger vehicle, trailer or other transport. The compressor can be constructed as a three-stage reciprocating compressor operably connected to a hydraulic motor through a rotary-to-linear transmission.

### RELATED APPLICATIONS

This application claims the benefit of U.S. Provisional Patent Application Ser. No. 63/765,425 filed Feb. 28, 2025 and entitled, “Linear Natural Gas Compressor with Hydraulic Motor,” the disclosure of which is herein incorporated by reference.

### FIELD OF THE INVENTION

The subject matter disclosed herein relates to greenhouse gas emissions control devices, and more particularly to systems and methods designed to mitigate greenhouse gas emissions from pipelines, compressors and other sources of greenhouse gas emissions.

### BACKGROUND

Pipelines are often used to carry petroleum fluids over long distances. Devices referred to as “pigs” or “scrapers” are used on a periodic basis to examine pipelines for corrosion and damage, and to clean the pipeline of accumulated deposits from the petroleum products. The pig typically resembles a piston with an outer diameter that closely matches the inner diameter of the pipeline. Pressurized fluids—including the petroleum products flowing through the pipeline—can be used to push the pig through the pipeline.

Often, the pigging process involves deploying a pig into the pipeline through a “pig launcher” that is connected as an adjacent component to the pipeline. The pig is retrieved from the pipeline at a receiving station, which is sometimes called a “pig receiver” or “pig trap.” In some applications, the launcher and receiver are configured to both launch and receive the pig.

It will be appreciated that the pig launcher and the pig receiver are isolated from the pressurized fluids in the pipeline during the process of loading the pig into the pig launcher and removing the pig from the pig receiver. Pressurized fluids are carried into the launcher through a “kicker” line that extends from the pipeline to the launching station. By opening and closing valves on the pipeline, kicker line and launching station, pressurized fluids can be diverted from the operational pipeline into the launching station to push the pig out of the launching station and through the pipeline. Similarly, the receiving station is connected to the pipeline through a series of valves that can be opened to temporarily divert the flow of fluids from the pipeline into the receiving station as the pig enters the receiving station. Once the pig has been captured within the receiving station, the valves can be manipulated to return flow to the pipeline.

When the pig arrives at the receiving station the pressurized petroleum fluids are captured within the receiving station. To allow the pig to be safely removed through a door in the receiving station, the pressurized fluids are typically vented to the atmosphere. Once the pressure inside the receiving station has been equalized with the atmosphere, the door in the receiving station can be opened to permit the removal of the pig.

Fugitive emission of petroleum fluids may also arise from compressor operations, where pressurized greenhouse gases may traverse packing glands and seals within the compressor before being vented to atmosphere through lower pressure areas of the compressor, such as the crankcase.

In each case, the practice of venting pressurized petroleum fluids into the atmosphere presents an environmental concern. Petroleum fluids may include aggressive greenhouse gases such as carbon dioxide, methane (natural gas) or selected hydrocarbon species that are regulated as volatile organic compounds. There is, therefore, a need for an improved system for controlling hydrocarbon emissions from pipeline pigging and compressor operations.

### SUMMARY OF THE INVENTION

In some embodiments, the present disclosure is directed at a system for transferring gases from a source to a destination. The system includes a hydraulic pump, a hydraulic circuit, and a compressor connected to the hydraulic pump through the hydraulic circuit. The compressor has a first stage section, an inlet line connected between the source and the first stage section, a second stage section, a third stage section, a discharge line connected between the third stage section and the destination, and a common shaft extending through the first stage section, the second stage section, and the third stage section. The system further includes a hydraulic motor connected to the hydraulic pump through the hydraulic circuit and a transmission connected between the common shaft and the hydraulic motor, wherein the transmission comprises a rotary-to-linear mechanism.

In other embodiments, the present disclosure is directed at a system for recovering pressurized gas that would otherwise be vented to atmosphere. In these embodiments, the system includes a gas source defining an isolated volume of gas, a gas destination having a pressure equal to or greater than a pressure of the gas source, and a reciprocating gas compressor fluidly connected between the gas source and the gas destination and configured to transfer gas from the gas source to the gas destination without venting the gas to atmosphere. The system further incorporates a drive system operably coupled to the reciprocating gas compressor. The drive system includes a hydraulic pump that supplies a pressurized working fluid and a hydraulic motor driven by the pressurized working fluid and configured to impart reciprocating motion to the reciprocating gas compressor.

In yet other embodiments, the present disclosure is directed to a method of reducing greenhouse gas emissions from pipeline or compressor operations. The method includes the steps of isolating a volume of pressurized gas from a pipeline, pig trap, or compressor component, fluidly connecting the isolated volume of pressurized gas to a reciprocating compressor, driving the reciprocating compressor using energy derived from a pressurized working fluid, compressing the isolated volume of pressurized gas using the reciprocating compressor, and reintroducing the compressed gas into a pipeline, compressor suction, or compressor discharge line without venting the compressed gas to atmosphere. In some embodiments, the pressurized working fluid comprises hydraulic fluid supplied by a vehicle-mounted hydraulic pump. In some embodiments, the step of driving the reciprocating compressor using energy derived from the pressurized working fluid includes activating a hydraulic pump to pressurize the working fluid, energizing a hydraulic motor with the pressurized working fluid, and translating torque from the hydraulic motor to a reciprocating movement with a transmission between the hydraulic motor and the reciprocating compressor.

### BRIEF DESCRIPTION OF THE DRAWINGS

These and other features, aspects, and advantages of the present disclosure will become better understood when the following detailed description is read with reference to the accompanying drawings in which like characters represent like parts throughout the drawings, wherein:

FIG. 1 is a diagram illustrating the placement of an embodiment of the compressor between high pressure and lower pressure pipeline segments.

FIG. 2 provides a close-up diagram of the compressor of FIG. 1.

FIG. 3 is a process flow diagram for a method for transferring captured gases within a pig trap.

### WRITTEN DESCRIPTION

The present disclosure is generally directed at systems and methods for transferring gases from an isolated gas source to a destination. In some embodiments, the isolated gas source will be low pressure pig trap and the destination is a higher pressure pipeline segment. In other embodiments, the isolated gas source and the destination have pressures that are approximately the same. In other embodiments, the systems and methods disclosed herein can be used to capture and transfer fugitive gases from compressor operations by transporting gases trapped in crankcases, packing vents, and other low pressure regions in or around the compressor to a fuel stream to the compressor or a discharge line from the compressor. In each case, the systems and methods disclosed herein reduce or eliminate the release or production of greenhouse gases that would otherwise be vented to atmosphere during routine pipeline maintenance operations. Thus, in exemplary embodiments, systems and methods disclosed herein find particular utility in capturing and pressurizing hydrocarbon gases from a low pressure origin or other isolated gas source so that the captured hydrocarbon gases can be reintroduced into the pipeline, compressor or other destination in a manner that is more environmentally responsible than venting the captured hydrocarbon gases to the atmosphere.

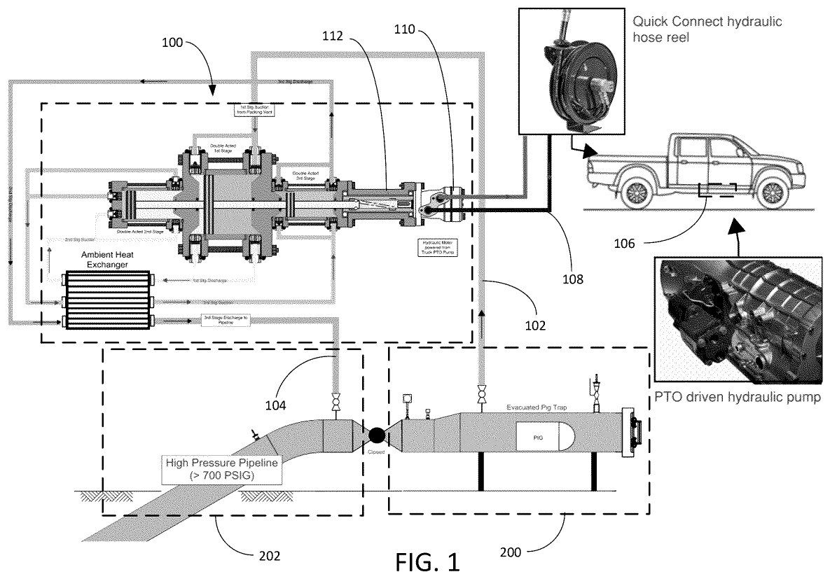

Turning to FIG. 1, shown therein is a compressor 100 constructed and deployed in accordance with an exemplary embodiment. The compressor 100 is generally used to transfer gases captured from a source 200 to a destination 202. In some embodiments, the pressure in the source 200 is lower than the pressure in the destination 204. In some embodiments, the source 200 is a pig catcher, a pig launcher, a pipeline segment, a gas compressor, a pressure vessel or another chamber that includes an isolated volume of gas, while the destination 202 is pipeline segment, a gas compressor, a pressure vessel, or another gas-filled chamber. It will be appreciated that the source 200 and destination 202 can each be part of the same pipeline system or vessel, or each part of multiple, separate pipelines or vessels. The source 200 can be connected to the compressor 100 through an inlet line 102. The compressor 100 can be connected to the destination 202 through a discharge line 104.

As used herein in the context of a pipeline, the term “segment” refers to a portion of a pipeline that is separated from adjacent portions of the pipeline by a fluid isolation mechanism, such as a valve, compressor, or other intervening mechanism or chamber. The term generally “low pressure” refers to pressures below 100 pounds per square inch (gauge)(“psig”). The term “medium pressure” refers to a pressure between 100 psig and 500 psig. The term generally “high pressure” refers to pressures above about 500 psig. It will be understood that the compressor 100 can be connected to pipeline systems operating between and beyond these pressure ranges. The compressor 100 is particularly well suited for pressurizing gases from the low pressure source 200 so the gases can be responsibly injected into the higher pressure destination 202.

The compressor 100 is driven by pressurized hydraulic fluid from a hydraulic pump 106. In the embodiment depicted in FIG. 1, the hydraulic pump 106 is incorporated onto or within a vehicle that includes a power-takeoff (PTO) unit. In other embodiments, the hydraulic pump 106 is a standalone hydraulic generator. The hydraulic pump 106 produces a source of pressurized fluid for a hydraulic circuit 108. The hydraulic circuit 108 extends from the hydraulic pump 106 to the compressor 100 and provides a discharge line from the pump 106 to the compressor 100 and a return line from the compressor 100 back to the hydraulic pump 106. In the specific embodiment, depicted in FIG. 1, the circuit 108 is a pair of quick-connect hydraulic hoses on a reel, which can be carried in the back of the pickup truck or other vehicle.

A hydraulic motor 110 converts a portion of the energy in the pressurized hydraulic fluid leaving the hydraulic pump 106 into torque. The torque produced by the hydraulic motor 110 is carried to the transmission 112 through one or more rotating shafts or couplers between the hydraulic motor 110 and the transmission 112. In exemplary embodiments, the transmission 112 includes a rotary-to-linear converter that transfers the rotating motion produced by the hydraulic motor 110 into reciprocating motion of the common shaft 120. In some embodiments, the transmission 112 is a swash-plate mechanism. In other embodiments, the transmission 112 includes a rotating collar with slots that engage with a linearly reciprocating carrier. As the collar rotates, the carrier is constrained against rotation, but permitted to move linearly as the carrier follows the rotating slot. In other embodiments, the hydraulic motor 110 is a linearly reciprocating motor that converts hydraulic pressure from the hydraulic pump 106 into a reciprocating motion that is passed directly to the common shaft 120.

Although the compressor 100 is designed to be driven by the hydraulic pump 106 and hydraulic motor 110, it will be understood that in other embodiments, the hydraulic pump 106 can be replaced with a source of pressurized gas that directly or indirectly drives the compressor 100. For example, the source of pressurized gas can be an air compressor or tank of pressurized air. In other embodiments, the source of pressurized gas can be a high pressure pipeline segment or discharge from a nearby compressor. In each case, the pressurized gas can be used as an alternative to pressurized hydraulic fluid to drive a pneumatic motor as a replacement for the hydraulic motor 110.

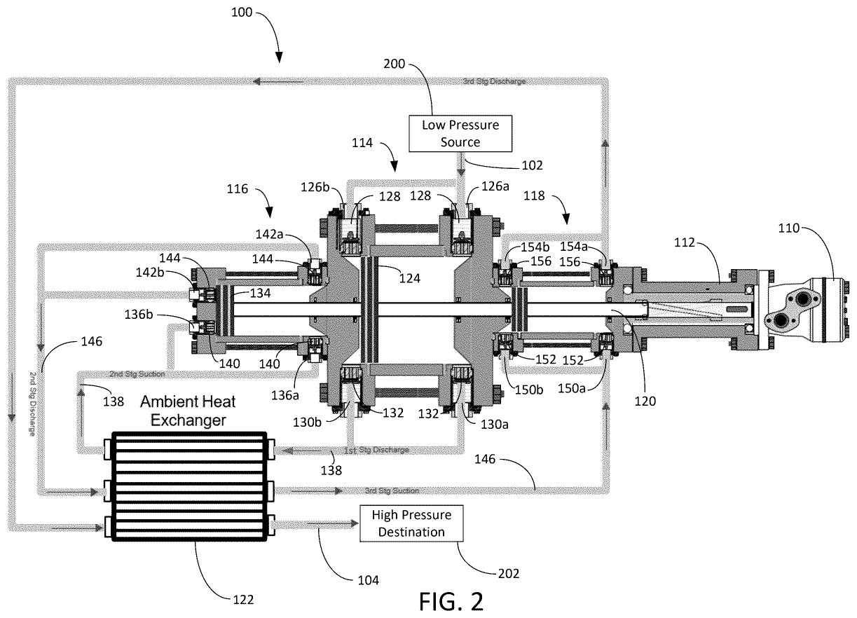

Turning to FIG. 2, shown therein is an enlarged view of an embodiment of the compressor 100. The compressor 100 includes a first stage section 114, a second stage section 116, a third stage section 118 and a common shaft 120 that extends through each of the sections 114, 116 and 118. The common shaft 120 can include a unitary shaft or a plurality of interconnected shaft segments. Each of the sections 114, 116 and 118 of the compressor 100 is generally configured as a hollow cylinder in which a piston connected to the common shaft 120 reciprocates. Each section 114, 116 and 118 is separated from adjacent sections by cylinder ends.

The compressor 100 may further include a heat exchanger 122. The heat exchanger 122 is configured to exchange heat between the gases passing between the stage sections 114, 116 and 118. The discharge from the first stage section 114 can be used to cool the discharge from the second stage section 116, which in turn can be used to cool the discharge from the third stage section 118 before it connects to the discharge line 104. In this way, the discharge gas from the first stage section 114, the second stage section 116 and the third stage section 118 is cooled by ambient air or other fluids or gases.

The first stage section 114 includes a first stage piston 124 and a pair of first stage inlets 126a, 126b. The first stage inlets 126a, 126b are positioned on opposite sides of the first stage piston 124 and connected to the low pressure inlet line 102. The first stage inlets 126a, 126b each include a one-way first stage inlet check valve 128 that is configured to permit the unidirectional flow of gas into the first stage section 114, while preventing the passage of gas out of the first stage section 114. In some embodiments, the first stage inlet check valves 128 are configured to open when the pressure differential across the first stage inlet check valves 128 reaches about 5 psig.

The first stage section 114 also includes a pair of first stage outlets 130a, 130b on opposite sides of the first stage piston 124 that each include a first stage outlet check valve 132. The first stage outlet check valves 132 are configured to permit the unidirectional flow of gas out of the first stage section 114, while preventing the passage of gas back into the first stage 114. In some embodiments, the first stage outlet check valves 132 are configured to open when the pressure differential across the first stage outlet check valves 132 reaches about 50 psig.

The first stage piston 124 is fixed in position on the shaft 120. As the shaft 120 reciprocates back and forth, the first stage piston 124 compresses the gas on alternating sides of the first stage piston 124. When the first stage piston 124 moves in a first direction, the first stage piston 124 compresses the gas on a first side of the first stage piston 124 until the pressure exceeds the opening pressure for the first stage outlet check valve 132 for the first stage outlet 130a. At the same time, the first stage piston 124 draws gas in through the first stage inlet 126b. When the direction of the shaft 120 changes, the first stage piston 124 compresses the gas on the second side of the first stage piston 124 while drawing in gas through the first stage inlet 126a. When the gas on the second side of the first stage piston 124 exceeds the opening force of the first stage outlet check valve 132, the gas is expelled through the first stage outlet 130b. In this way, the first stage section 114 is configured as a double-acting reciprocating compressor.

In the embodiment depicted, the first stage section 114 has larger outer and inner diameters than the second and third stage sections 116, 118. The larger surface area of the first stage piston 124 permits the first stage section 114 to operate efficiently under the lower pressures of the gas from the low pressure source 200.

The second stage section 116 includes a second stage piston 134 and a pair of second stage inlets 136a, 136b positioned on opposite sides of the second stage piston 134. The second stage inlets 136a, 136b are connected to the first stage outlets 130a, 130b with a first interstage line 138. The second stage inlets 136a, 136b each include a second stage inlet check valve 140 that permits the flow of gas from the interstage line 138 into the second stage section 116, while prohibiting the flow of gas from the second stage section 116 back into the first interstage line 138. In some embodiments, the second stage inlet check valves 140 are configured to open at about 50 psig (pounds per square inch gauge).

The second stage section 116 also includes a pair of second stage outlets 142a, 142b that each include a second stage outlet check valve 144. The second stage outlets 142a, 142b are positioned on opposite sides of the second stage piston 134. In some embodiments, the second stage outlet check valves 144 can be configured to open at about 250 psig to permit the flow of gas from the second stage section 116 into a second interstage line 146, while prohibiting flow from the second interstage line 146 back into the second stage section 116. The second stage piston 134 is smaller than the first stage piston 124 to accommodate the step-up in pressure between the first and second stage sections 114, 116.

The second stage piston 134 is fixed to the shaft 120 and configured as a double-acting reciprocating compressor. During use, the second stage piston 134 reciprocates between first and second positions as the shaft 120 is driven back and forth. In a first direction, the second stage piston 134 compresses gas inside the first side of the second stage section 116 until the pressure meets or exceeds the line pressure in the low pressure destination segment 104 and the gas is expelled through the second stage outlet 142a, 142b. While the second stage piston 134 is moving in the first direction, the second stage inlet check valve 140 for the second stage inlet 136b opens to admit gas from the first interstage line 138 into the second stage section 116. When the direction of the second stage piston 134 changes, the second stage piston 134 compresses the gas on the second side of the second stage section 116 until the pressure exceeds the opening pressure of the applicable second stage outlet check valve 144 and the gas is expelled through the second stage outlet 142b. The second stage outlets 142a, 142b are connected to the second interstage line 146, which is in turn connected to the third stage section 118.

The third stage section 118 includes a third stage piston 148 and a pair of third stage inlets 150a, 150b positioned on opposite sides of the third stage piston 148. The third stage inlets 150a, 150b are connected to the second stage outlets 142a, 142b through the second interstage line 146. The third stage inlets 150a, 150b each include a third stage inlet check valve 152 that permits the flow of gas from the second interstage line 146 into the third stage section 118, while prohibiting the flow of gas from the third stage section 118 back into the second interstage line 146. In some embodiments, the third stage inlet check valves 140 are configured to open at about 250 psig.

The third stage section 118 also includes a pair of third stage outlets 154a, 154b that each include a third stage outlet check valve 156. The third stage outlets 154a, 154b are positioned on opposite sides of the third stage piston 148. In some embodiments, the third stage outlet check valves 156 can be configured to open at about 1000 psig to permit the flow of gas from the third stage section 118 into the discharge line 104, while prohibiting flow from the discharge line 104 back into the third stage section 118. The third stage piston 148 can be smaller than the second stage piston 134 to accommodate the step-up in pressure between the first and second stage sections 114, 116.

The third stage piston 148 is fixed to the shaft 120 and configured as a double-acting reciprocating compressor. During use, the third stage piston 148 reciprocates between first and second positions as the shaft 120 is driven back and forth. In a first direction, the third stage piston 148 compresses gas inside the first side of the third stage section 118 until the pressure meets or exceeds the pressure in the discharge line 104 and the gas is expelled through the third stage outlets 154a, 154b. While the third stage piston 148 is moving in the first direction, the third stage inlet check valve 152 for the third stage inlet 150b opens to admit gas from the second interstage line 146 into the third stage section 118. When the direction of the third stage piston 148 changes, the third stage piston 148 compresses the gas on the second side of the third stage section 118 until the pressure exceeds the opening pressure of the applicable third stage outlet check valve 156 and the gas is expelled through the third stage outlet 154b. The third stage outlets 154a, 154b are connected to the discharge line 104, which leads to the destination 202.

In the embodiments depicted in FIGS. 1-2, the first stage section 114 is positioned between the second stage section 116 and third stage section 118. It will be appreciated that the particular arrangement of the various sections 114, 116 and 118 can be rearranged in other embodiments. In some embodiments, the compressor 100 includes one or two stages driven by the hydraulic motor 110. In other embodiments, the compressor 100 includes more than three stages.

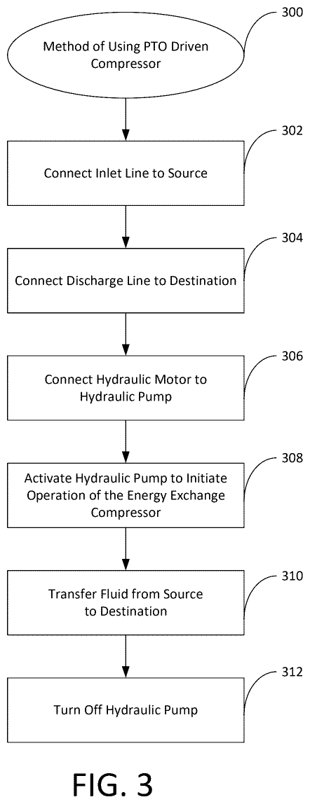

Thus, in exemplary embodiments, the compressor 100 is configured to transfer gas from a source 200 to the destination 202 (e.g., a suction line to a pipeline compressor) using a drive system that includes a hydraulic motor driven, a hydraulic pump, and a transmission. The hydraulic pump can be mounted on a vehicle, skid or dedicated power unit. Turning to FIG. 3, shown therein is a process flowchart for an exemplary method 300 for transferring captured gases from the low pressure source 200 to the higher pressure destination 202. The method begins at step 302 when inlet line 102 is connected to the source 200. Next, at step 304, the discharge line 104 is connected to the destination 202. At step 306, the hydraulic pump 106 is connected to the hydraulic motor 110 using the hydraulic circuit 108.

At step 308, the compressor 100 is activated by turning on the hydraulic pump 106 or by otherwise providing pressurized hydraulic fluid to the hydraulic motor 110. The hydraulic motor 110 drives the compressor 100 through the transmission 112. At step 310, the compressor 100 draws gas out of the source 200 and delivers the gas to the destination 202. During the operation of the compressor 100, additional energy from the hydraulic pump 106 and hydraulic motor 110 may be required to operate the compressor 100. In some embodiments, the hydraulic pump 106 is configured to automatically adjust its output in response to increased load from the compressor 100.

Once the pressure inside the source 200 falls below a threshold level (e.g., 5 psig), the compressor 100 can be turned off by shutting down the hydraulic pump 106. The hydraulic circuit 108 can be disconnected from the hydraulic motor 110 and the vehicle with the hydraulic pump 106 and hydraulic circuit 108 can be driven away from the compressor 100. It will be appreciated that in some embodiments, the compressor 100 is also located on the vehicle and persistently connected to the hydraulic pump 106. In these embodiments, the compressor 100 is connected and disconnected between the source 200 and destination 202 while the compressor 100 remains in the vehicle.

It is to be understood that even though numerous characteristics and advantages of various embodiments of the present invention have been set forth in the foregoing description, together with details of the structure and functions of various embodiments of the invention, this disclosure is illustrative only, and changes may be made in detail, especially in matters of structure and arrangement of parts within the principles of the present invention to the full extent indicated by the broad general meaning of the terms in which the appended claims are expressed. It will be appreciated by those skilled in the art that the teachings of the present invention can be applied to other systems without departing from the scope and spirit of the present invention.

What is claimed is:

1. A system for transferring gases from a source to a destination, the system comprising:
a hydraulic pump;
a hydraulic circuit; and
a compressor connected to the hydraulic pump through the hydraulic circuit, wherein the compressor comprises:
a first stage section;
an inlet line connected between the source and the first stage section;
a second stage section;
a third stage section;
a discharge line connected between the third stage section and the destination;
a common shaft extending through the first stage section, the second stage section, and the third stage section;
a hydraulic motor connected to the hydraulic pump through the hydraulic circuit; and
a transmission connected between the common shaft and the hydraulic motor, wherein the transmission comprises a rotary-to-linear mechanism.

2. The system of claim 1, wherein the first stage section is connected to the second stage section with a first interstage line.

3. The system of claim 2, wherein the second stage section is connected to the third stage section with a second interstage line.

4. The system of claim 3, wherein the compressor further comprises a heat exchanger, wherein the heat exchanger is connected on the interstage line, the second interstage line, and the discharge line.

5. A system for recovering pressurized gas that would otherwise be vented to atmosphere, comprising:
a gas source defining an isolated volume of gas;
a gas destination having a pressure equal to or greater than a pressure of the gas source;
a reciprocating gas compressor fluidly connected between the gas source and the gas destination and configured to transfer gas from the gas source to the gas destination without venting the gas to atmosphere; and
a drive system operably coupled to the reciprocating gas compressor, wherein the drive system comprises:
a hydraulic pump that supplies a pressurized working fluid; and
a hydraulic motor driven by the pressurized working fluid and configured to impart reciprocating motion to the reciprocating gas compressor.

6. The system of claim 5, wherein the drive system further comprises a rotary-to-linear transmission between the hydraulic motor and the reciprocating gas compressor.

7. The system of claim 5, wherein the pressurized working fluid comprises hydraulic fluid, compressed air, or pressurized natural gas.

8. The system of claim 5, wherein the reciprocating gas compressor comprises one or more compression stages arranged in series.

9. The system of claim 8, wherein at least one compression stage is configured as a double-acting reciprocating stage.

10. The system of claim 5, wherein the gas source comprises a pig launcher, a pig receiver, a pig trap, a compressor crankcase, or a compressor packing vent.

11. A method of reducing greenhouse gas emissions from pipeline or compressor operations, comprising:
isolating a volume of pressurized gas from a pipeline, pig trap, or compressor component;
fluidly connecting the isolated volume of pressurized gas to a reciprocating compressor;
driving the reciprocating compressor using energy derived from a pressurized working fluid;
compressing the isolated volume of pressurized gas using the reciprocating compressor; and
reintroducing the compressed gas into a pipeline, compressor suction, or compressor discharge line without venting the compressed gas to atmosphere.

12. The method of claim 11, wherein the pressurized working fluid comprises hydraulic fluid supplied by a vehicle-mounted hydraulic pump.

13. The method of claim 11, wherein the step of driving the reciprocating compressor using energy derived from the pressurized working fluid further comprises:
activating a hydraulic pump to pressurize the working fluid;
energizing a hydraulic motor with the pressurized working fluid; and
translating torque from the hydraulic motor to a reciprocating movement with a transmission between the hydraulic motor and the reciprocating compressor.

14. The method of claim 13, wherein the transmission comprises a rotary-to-linear transmission.

15. The method of claim 11, wherein the isolated volume of pressurized gas is isolated during a pipeline pigging operation.

16. The method of claim 11, wherein reintroducing the compressed gas comprises injecting the compressed gas into a suction line of a pipeline compressor.

17. The method of claim 11, wherein the isolated volume of pressurized gas has an initial pressure of less than about 100 psig.

18. The method of claim 11, wherein the method is performed without requiring electrical power at the site of the reciprocating compressor.
